(19) United States
(12) Patent Application Publication
(10) Pub. No.: US 2017/0115996 A1
(43) Pub. Date: Apr. 27, 2017

(54) REBOOT SYSTEM AND METHOD FOR BASEBOARD MANAGEMENT CONTROLLER

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: KANG WU, Shenzhen (CN)

(21) Appl. No.: 14/946,195

(22) Filed: Nov. 19, 2015

(30) Foreign Application Priority Data
Oct. 21, 2015 (CN) 201510693101.6

(51) Int. Cl. G06F 9/44; G06F 13/40

(52) U.S. Cl. CPC G06F 9/4406; G06F 13/4027; G06F 13/4068

(57) ABSTRACT

A reboot system for rebooting a baseboard management controller includes an input and output extension chipset and a control chipset coupled to the input and output extension chipset. A general purpose pin of the input and output extension chipset is coupled to a reboot pin of the baseboard management controller and further coupled to a high level signal voltage source. The control chipset sends a reboot signal to the input and output extension chipset to control the input and output extension chipset to output a low level signal from the general purpose pin to the reboot pin of the baseboard management controller to reboot the baseboard management controller when the controller fails to work normally.

This application claims priority to Chinese Patent Application No. 201510693101.6 filed on Oct. 21, 2015, the contents of which are incorporated by reference herein.

### FIELD

The subject matter herein generally relates to system rebooting of an electronic device.

### BACKGROUND

Electronic devices, such as servers, can be monitored while the electronic devices are running An electronic device often comprises a Baseboard Management Controller (BMC) to monitor variety of different states of the electronic device, such as input voltage, temperature, power consumption, alarm information, and bug information.

### BRIEF DESCRIPTION OF THE DRAWINGS

Implementations of the present technology will now be described, by way of example only, with reference to the attached figures.

FIG. 1 is a block view of one reboot system for a BMC.

FIG. 2 is a circuit diagram of the reboot system of FIG. 1.

FIG. 3 is a flow chart of one reboot method for a BMC.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

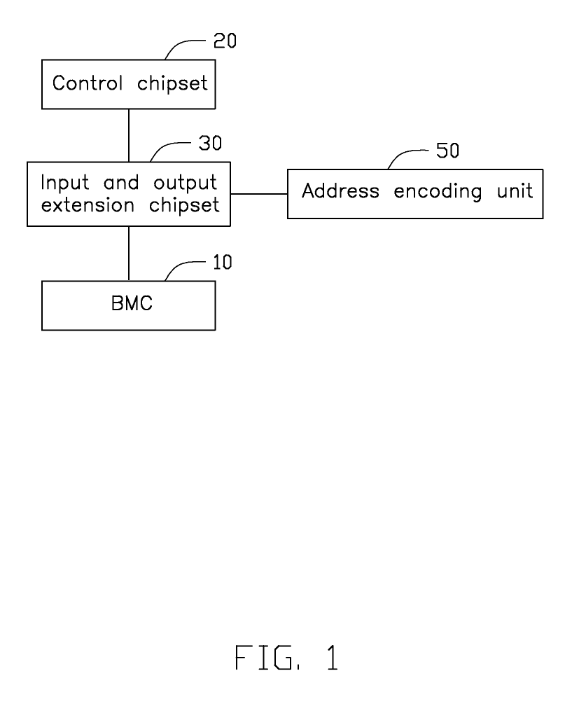

FIG. 1 illustrates a reboot system for rebooting a Baseboard Management Controller (BMC) 10 in accordance with an embodiment. The reboot system comprises a control chipset 20, an input and output extension chipset 30, and an address encoding unit 50. The control chipset 20 is coupled to the input and output extension chipset 30. The input and output extension chipset 30 is coupled to the BMC 10. The address encoding unit 50 is coupled to the input and output extension chipset 30. In one embodiment, the control chipset 20 is a south bridge chipset or a peripheral control hub.

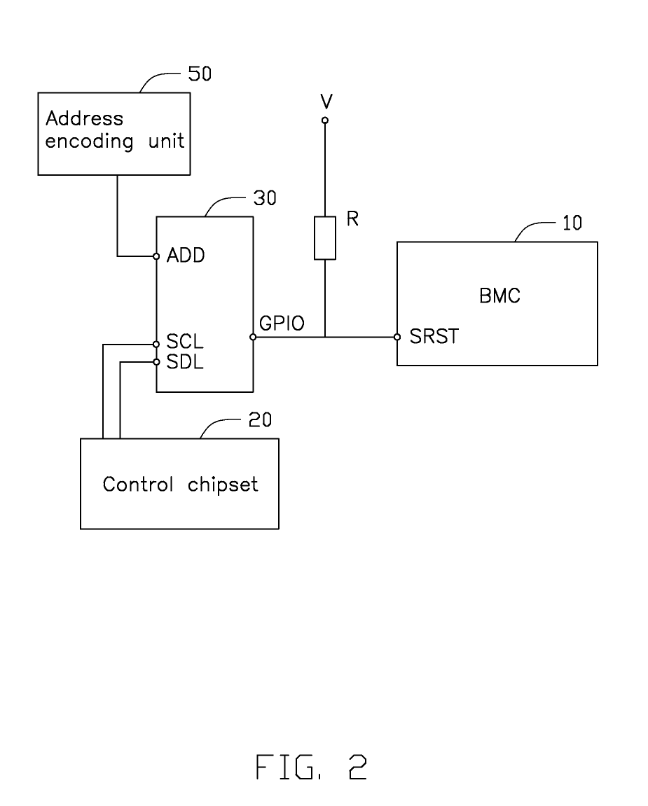

FIG. 2 illustrates a circuit diagram of the reboot system. The BMC 10 comprises a reboot pin SRST. The input and output extension chipset 30 comprises a general purpose pin GPIO, at least one address pin ADD, a first signal pin SCL, and a second signal pin SDL.

The general purpose pin GPIO of the input and output extension chipset 30 is coupled to the reboot pin SRST of the BMC 10, and further coupled to a high level voltage source V via a resistor R. The BMC 10 can reboot when the reboot pin SRST receives a low level voltage signal.

The address pin ADD of the input and output extension chipset 30 is coupled to the address encoding unit 50. Therefore, the address encoding unit 50 encodes an access address for the input and output extension chipset 30.

The first signal pin SCL and the second signal pin SDL of the input and output extension chipset 30 together builds up an Inter-Integrated Circuit (I2C) port. The control chipset 20 is coupled to the input and output extension chipset 30 via an I2C bus and the I2C port formed by the first and signal pins SCL and SDL.

When the BMC 10 works normally, the reboot pin SRST of the BMC 10 continually receives the high level voltage source V to prevent the BMC from being rebooted.

When the BMC 10 fails to work normally, the control chipset 20 sends a reboot signal to the input and output extension chipset 30. The input and output extension chipset 30 receives the reboot signal and outputs a low level voltage pulse signal from the general purpose pin GPIO to the reboot pin SRST of the BMC 10. Thus, the BMC 10 is rebooted.

In the above reboot system, the BMC can be rebooted without restarting the whole system or shutting down other electronic components.

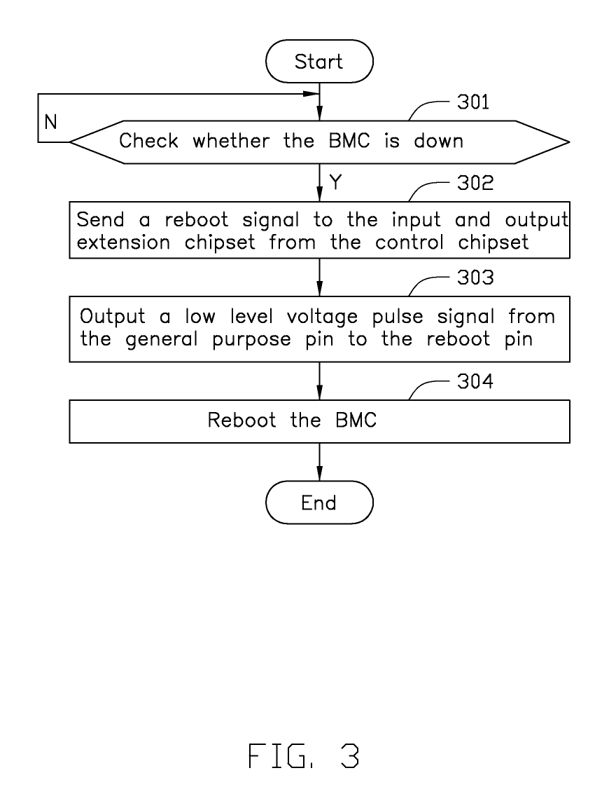

FIG. 3 illustrates a flow chart of a method for rebooting the BMC 10 which comprises following steps.

At block 301, check whether the BMC 10 is down. If the BMC 10 is down, go to step 301.

At block 302, send a reboot signal to the input and output extension chipset 30 from the control chipset 20.

At block 303, output a low level voltage pulse signal from the general purpose pin GPIO of the input and output extension chipset 30 to the reboot pin SRST of the BMC 10.

At block 304, reboot the BMC 10.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to, and including, the full extent established by the broad general meaning of the terms used in the claims. It will therefore be appreciated that the embodiments described above may be modified within the scope of the claims.

What is claimed is:

1. A reboot system for rebooting a baseboard management controller, the reboot system comprising:
a baseboard management controller;
an input and output extension chipset comprising a general purpose pin, the general purpose pin coupled to a reboot pin of the baseboard management controller and further coupled to a power source; and
a control chipset coupled to the input and output extension chipset; and
configured to send, when the baseboard management controller is down, a reboot signal to the input and output extension chipset to control the input and output extension chipset to output a pulse signal from the general purpose pin to the reboot pin of the baseboard management controller to reboot the baseboard management controller.

2. The reboot system of claim 1, wherein the power source is a high level voltage source, and the pulse signal is a low level voltage pulse signal.

3. The reboot system of claim 1, wherein the input and output extension chipset comprises an address pin, an address encoding unit is coupled to the address pin to encode an access address for the input and output extension chipset.

4. The reboot system of claim 3, wherein the control chipset sends the reboot signal to the input and output extension chipset based on the access address of the input and output extension chipset.

5. The reboot system of claim 1, wherein input and output extension chipset comprises a first signal pin and a second signal pin, the first signal pin and the second signal pin are coupled to the control chipset.

6. The reboot system of claim 5, wherein the first signal pin and the second signal pin together builds up an Inter-Integrated Circuit (I2C) port, and the control chipset is coupled to the I2C port via a I2C bus.

7. The reboot system of claim 1, wherein the control chipset is a south bridge chipset.

8. The reboot system of claim 1, wherein the control chipset is a peripheral control hub.

9. A reboot method for rebooting a baseboard management controller, the reboot method comprising:
a control chipset sending a reboot signal to an input and output extension chipset;
the input and output extending chipset outputting a pulse signal to a reboot pin of a base board management controller; and
rebooting the baseboard management controller.

10. The reboot method of claim 9, wherein the input and output extending chipset comprises a general purpose pin coupled to the reboot pin, the reboot pin is coupled to a power source.

11. The reboot method of claim 10, wherein the power source is a high level voltage source, and the pulse signal is a low level voltage pulse signal.

12. The reboot method of claim 9, wherein the input and output extension chipset comprises an address pin, an address encoding unit is coupled to the address pin to encode an access address for the input and output extension chipset.

13. The reboot method of claim 12, wherein the control chipset sends the reboot signal to the input and output extension chipset based on the access address of the input and output extension chipset.

14. The reboot system of claim 9, wherein input and output extension chipset comprises a first signal pin and a second signal pin, the first signal pin and the second signal pin are coupled to the control chipset.

15. The reboot system of claim 14, wherein the first signal pin and the second signal pin together builds up a I2C port, and the control chipset is coupled to the I2C port via a I2C bus.
